(19) United States
(12) Patent Application Publication
(10) Pub. No.: US 2008/0094634 A1
(43) Pub. Date: Apr. 24, 2008

(54) Phase Determination System and Method

(76) Inventors: Jacob Rubinstein, Bloomington, IN (US); Gershon Wolansky, Jerusalem (IL)

Correspondence Address: DANIEL J SWIRSKY, 55 REUVEN ST., BEIT SHEMESH, 99544, IL

(21) Appl. No.: 11/575,351

(22) PCT Filed: Sep. 29, 2005
(86) PCT No.: PCT/US05/34926

§ 371 Date: Mar. 15, 2007

Related U.S. Application Data
(60) Provisional application No. 60/615,038, filed on Oct. 1, 2004.

(51) Int. Cl. G01B 9/00

(52) U.S. Cl. 356/450

(57) ABSTRACT

The present invention relates to the field of optics, and, in particular to a system and method for determining the phase of a wave. The system and method of the present invention calculates the phase of any type of wave based on the intensity of the wave. In particular, the system and method provides a means for finding the ray mapping between two surfaces in space from information on the wave's intensity measured at those two surfaces.

### CROSS REFERENCE TO RELATED APPLICATION

This application claims the benefit of U.S. Provisional Patent Application No. 60/615,038 filed Oct. 1, 2004.

### FIELD OF THE INVENTION

The present invention relates to the field of optics, and, in particular to a system and method for determining the phase of a wave.

### BACKGROUND OF THE INVENTION

A central problem in the field of optics is determining the phase of a wave. The need to find the phase arises in a variety of applications including adaptive optics, astronomy and ophthalmic optics. The problem of phase determination is particularly difficult when the phase is not very close to being planar or spherical, and therefore interferometry methods are difficult to apply. A variety of devices, called phase sensors, have been developed to measure the phase of a wave.

Such phase sensors are useful in a variety of applications. For example, in opthalmology, aberrometers are devices that utilize a phase sensor to measure the phase of a wave to characterize a subject's vision. An aberrometer sends a narrow beam of light from outside the eye into the eye to interact with the retina. When the beam interacts with the retina, a light source is created at a point in the center of the retina. This light source expands as the waves travel outside the eye from the retina. During this travel, the wavefront, (as is consistent with common practice in the art, the terms “phase” and “wavefront” are used interchangeably in this application for convenience, even though technically the term “phase” refers to the fundamental object that characterizes the wave and the term “wavefront” refers to the surface in space where the phase is constant) that is initially spherical near the retinal source point, is refracted and distorted. If the eye is perfect, the wavefront emerging from the eye would be exactly planar, implying that a distant object is exactly imaged at the retina. Or, if the subject is a “perfect” myope (near-sighted), the emerging wavefront would be spherical about some point outside the eye, and the subject would have perfect focusing ability with respect to this point. In practice, no subject has a perfect eye, however, and, thus, the emerging wavefront has a nonplanar and nonspherical form.

Aberrometers contain a phase sensor to measure the refracted wavefront of light outside the eye. The measured phase is used to characterize the subject's vision. For example, from the phase measurement of an aberrometer, one can, in principle, determine the prescription for the subject to improve the subject's vision. In practice, the measured wavefront is often supplied to the operator of the aberrometer, not as a function, but as an array of numbers referred to as “aberrations”. The first few aberrations are related to the subject's eye prescription. Additional numbers, referred to as “higher aberrations”, are supplied by the aberrometer, but these higher aberrations are generally not measured in most eye examinations.

Aberrometers, or like devices, have many potential applications. In refractive surgery (i.e., Lasik surgery), where a surgeon ablates the cornea to correct a subject's vision, the ablation process might create unwanted aberrations that were not present before the surgery. Therefore, surgeons often use an aberrometer for quality control purposes. Another promising potential application of aberrometers is its use in optometrist's office as a faster and reliable means for determining a subject's need for visual correction, and even for better design of visual aid for the subject.

A widely used general phase sensor in aberrometers is the Hartmann-Shack device. It consists of an array of lenslets that convert an incoming beam into spots of light on a detection screen. This sensor has a number of drawbacks: the resolution is limited by the size of lenslets; the location of the spot centroids is hard to determine accurately; and the transformation from the location of the centroids of the spots to the phase gradient is only approximate. It is desired to provide a system and a method for determining the phase of a wave that does not suffer from these drawbacks.

Another means that can be used by a system with phase sensors to determine the phase of a wave is the Fermat principle, which is one of the pillars of optics. The principle lies at the foundations of geometrical optics, where it provides a theoretical and computational tool to find ray trajectories, and hence the phase of a wave. Fermat postulated that a light ray travels between two specified points so as to minimize the action ∫ndl, where n is the refraction index of the medium. The Fermat principle requires that one be given the terminal points of a ray. Because the terminal points of a ray are difficult to obtain and not always available, it is also desired to provide a system and method for determining phase without requiring the terminal points of a ray.

Unlike the terminal points of a ray, it is relatively easy to measure a wave's intensity. It is therefore tempting to seek methods for finding the phase from intensity measurements. Indeed, such a phase sensor was proposed in the “Deterministic Phase Retrieval: A Green's Function Solution” article by M. R. Teague that appeared in the 1983 Journal of the Optical Society of America, Volume 73 at pages 1434-1441 (the “Teague Article”), which is incorporated herein by reference. To explain the idea behind such sensors (sometimes called “curvature sensors”), consider a wave u in the Fresnel regime where the wave equation in a homogeneous medium is given by:

$$- i \frac{\partial u}{\partial z} = ku + \frac{1}{2 k} Δ u . \qquad ( 1 )$$

Here, z is the main direction of propagation, u is the wave function, k is the wave number, and □ and Δ denote, respectively, the gradient and laplacian operators in the plane orthogonal to z. Writing u=Ae^{ikφ}, we obtain for the real and imaginary parts of equation (1):

$$\begin{matrix}- \frac{\partial A}{\partial z} = \frac{1}{2 A} ∇ ( {A}^{2} ∇ ϕ ) , & ( 2 ) \\ \frac{\partial ϕ}{\partial z} = 1 + \frac{1}{{k}^{2} A} Δ A - \frac{1}{2} {\vert ∇ ϕ \vert}^{2} . & ( 3 )\end{matrix}$$

The first equation can be written more conveniently as an equation for the intensity I=A²:

$$- \frac{\partial I}{\partial z} = ∇ \cdot ( I ∇ ϕ ) . \qquad ( 4 )$$

Equation (4) is called the Transport of Intensity Equation (“TIE”). The Teague Article points out that equation (4) can be thought of as an elliptic partial differential equation for the phase φ in terms of the intensity I. Thus, the Teague Article considered equation (4) over some domain D in a plane z=z₀, and solved it under prescribed boundary conditions (the Dirichlet problem). We note that strictly speaking the phase is kφ, but, herein we shall refer to φ alone also as the phase.

The difficulty with the Teague Article's method is that the values of the phase at the boundary ∂D are not easy to measure. A number of algorithms related to equation (4) that attempted to resolve this issue were suggested, but none of them are fully satisfactory. Another drawback of the approach based on solving equation (4) is that it requires the computation of the derivative of the intensity. It is well-known that differentiation of data may amplify measurement errors.

Notice that the TIE is only one half of the Fresnel equation. Clearly, a proper solution must satisfy the other half of system (3) and (4) as well. This raises the following question: whether the intensity I measured at two planes Z=Z₁, Z=Z₂ can be used to determine the phase by considering jointly equations (4) and (3). The measurement of the intensity at two planes is also required for the TIE itself, because one needs to find, not only the intensity I, but also its derivative I_{z}. Computing this derivative requires one to measure the intensity at two near-by planes. In the present invention, however, the two planes can be arbitrarily located and do not need to be two near-by planes.

A partial answer to this question of whether intensity measured at two arbitrary planes could be used to determine phase was given by the “Wavefront Sensing From Defocused Images By use of Wavefront Slopes” article by M. A. van Dam and R. G. Lane that appeared in the 2002 Applied Optics, Volume 41 at pages 5497-502 (the “Lane Article”), which is incorporated herein by reference. The Lane Article realized that if the wave, confined to both observation planes, depends only on one variable, and if the rays do not intersect, one can order the initial and terminal points of the rays on the two respective screens such that all successive pairs of rays hold between them the same amount of total intensity. Once the ray endpoints are known, one can determine the phase slopes, and from the slopes the phase itself. The Lane Article asserts that it is not possible to extend the method to find such a ray mapping between points in a general two-dimensional setting. It is therefore desired to provide a system and method for determination of a phase of a general wave based on intensities measured at arbitrarily located planes and that overcomes all the shortcomings of the systems and methods described above.

### BRIEF SUMMARY OF THE INVENTION

The present invention relates to the field of optics, and in particular, to a system and method for determining the phase of a wave. For example, one device that can be made in accordance with the present invention comprises a first screen and a second screen located in two separate positions, that may or may not be in arbitrary positions, in order to measure a first intensity and a second intensity of a wave at the two separate positions. The first and second screens are each operatively connected to a processor, such as a computer, so that the measured first and second intensities can be transferred to the processor. The processor is able to construct the optimal mapping of the rays of the wave from the first and second measured intensities and to calculate the phase of the wave from the constructed optimal mapping.

An exemplary method of determining the phase of the wave utilizes this device to measure a first intensity of the wave with the first screen and a second intensity of the wave with the second screen. The method constructs the optimal mapping of the rays of the wave with the processor from the first and second intensities and then calculates the phase of the wave with the processor from the constructed optimal mapping. As explained in more detail below, the processor of this exemplary device and method can construct the optimal mapping by utilizing any number of algorithms, including but not limited to, a linear programming optimization or a steepest descent flow.

Any number of screens can be operatively connected to the processor and can be used to measure any number of intensities. The processor can construct the optimal mapping based on all the measured intensities provided by the screens. Moreover, the phase of any type of wave can be determined utilizing these devices and methods and no assumption is made about the type of wave that is being measured, which is significant because other phase measuring devices are based on the assumption that the wave is paraxial. For example, the methods and devices of the present invention can be used to determine the phase of a paraxial, non-paraxial, symmetric, non-symmetric, spherical or non-spherical wave. The processor can comprise any type of device capable of making the necessary calculations, including but not limited to, a computer or microprocessor.

### BRIEF DESCRIPTION OF THE DRAWINGS

FIG. 1 shows a schematic diagram of a wavefront propagating toward the first and second screens of one embodiment of the present invention; and

FIG. 2 shows a block diagram of one embodiment of a system according to the present invention.

### DETAILED DESCRIPTION OF THE INVENTION

The present invention relates to a system and method for determining a wave's phase. In particular, one embodiment of the present invention provides a system and method for finding the ray mapping between two surfaces in space based on the intensities measured at the two surfaces, and determining phase from the ray mapping. To achieve the aforementioned system and method, a new variational principle in optics is derived and presented herein that measures intensities of the wave at two planes and uses this information to determine the phase of the wave by considering jointly equations (4) and (3). To jointly consider equations (4) and (3) for phase reconstruction, equation (3) is incorporated in the analysis of the Teague article, discussed above, by expressing the phase φ in the form:
φ=z+ψ(x, z), (5)
where x denotes a point in the plane R², and ψ is the perturbation of the phase about the planar term z. By substituting equation (5) into equation (3), one obtains for ψ(x,z):

$$\frac{\partial ψ}{\partial z} + \frac{1}{2} {\vert ∇ ψ \vert}^{2} = \frac{1}{2 {k}^{2} A} Δ A . \qquad ( 6 )$$

In the small wavelength approximation, neglect the term on the right hand side and replace equation (6) by

$$\frac{\partial ψ}{\partial z} + \frac{1}{2} {\vert ∇ ψ \vert}^{2} = 0. \qquad ( 7 )$$

The above discussion on the phase reconstruction is limited to homogeneous media. The variational principle further derived below, however, is applicable to arbitrary media. When the refraction index n is not constant, the term ½(n²−1) needs to be included in the right hand side of equation (6). Thus, the optical problem considered consists of the following equations and boundary conditions:

$$\begin{matrix}\frac{\partial I}{\partial z} + ∇ \cdot ( I ∇ ψ ) = 0 , & ( 8 ) \\ \frac{\partial ψ}{\partial z} + \frac{1}{2} {\vert ∇ ψ \vert}^{2} = \frac{1}{2} ( {n}^{2} - 1 ) := P ( x , z ) . & ( 9 )\end{matrix}$$

Here, xεR², zε[Z₁, Z₂], I(z=Z₁,x)=I₁(x), I(z=Z₂,X)=I₂(x), where I₁ and I₂ are two given intensity distributions. Equations (8) and (9) together with the side conditions are denoted herein collectively as problem (Op). In the next section it is shown that problem (Op) can be solved by certain optimization problems.
The Variational Problem I: The Paraxial Limit

Consider two planes P₁: z=Z₁ and P₂:z=Z₂. Let I₁ and I₂ be two nonnegative functions given on P₁ and P₂. Optically, the functions I₁ and I₂ are the measured intensities; mathematically, however, they can be considered as arbitrary density functions. Assume that the intensities are normalized to one, and that they have finite second moments:
∫I₁(x)dx=∫I₂(x)dx=1, ∫x²Iᵢ(x)dx<∞i=1, 2. (10)
Recall from geometrical optics that, if a point xεP₁ is mapped by a ray into a point yεP₂, if the refraction index near P₁ and P₂ is the same, and if the ray is approximately orthogonal to the planes, then the intensities are related by:
I₁(x)=I₂(T(x))|J(T)|. (11)
Here, T(x) is the ray mapping from P₁ to P₂, and J(T) is the Jacobian of this mapping. The relation between transport equations such as (8) and the Jacobian of the ray mapping is well known in optics (See, e.g., Asymptotic Methods for Partial Differential Equations: The Reduced Wave Equation and Maxwell's Equations, Surveys in Applied Mathematics, Vol. 1, J. B. Keller et al. Editors, 1-82 (Plenum Press, 1993), which is incorporated herein by reference). We shall say that a mapping T satisfying the relation (11) transports I₁ to I₂. Use the formal notation:
T_{#}I₁=I₂. (12)

A first variational principle according to the present invention, denoted by problem (Mp), is

Find a map T̅ such that, T̅_{#}I₁=I₂ and
M(I₁,I₂, T̅):=∫Q(x, T̅(x))I₁(x)dx≦∫Q(x,T(x))I₁(x)dx∀T_{#}I₁=I₂, (13)

where the action Q is given by

$$Q ( x , y ) := Q ( x , y , {Z}_{1} , {Z}_{2} ) ≡ min {\int }_{{Z}_{1}}^{{Z}_{2}} ( \frac{1}{2} {\vert \frac{ⅆ x}{ⅆ z} \vert}^{2} + P ( x ( z ) , z ) ) ⅆ z , \qquad ( 14 )$$

and where the minimization is among all orbits x(z) such that x(Z₁)=x, x(Z₂)=y. The functional M defined in equation (13) will be called a weighted least action functional. Other weighted least action functionals will be defined later in the left hand sides of equations (15) and (27). As will be explained below, different optical setups call for the use of different weighted least action functionals.

In the homogeneous case (P≡0), the action reduces to:

$$Q ( x , y ) = \frac{{\vert x - y \vert}^{2}}{2 ( {Z}_{2} - {Z}_{1} )} .$$

In this case, the variational principle (Mp) becomes the quadratic Monge problem (Mpq):

Find a map T̅ such that, T̅_{#}I₁=I₂ and
∫| T̅(x)−x|²I₁(x)dx≦∫|T(x)−x|²I₁(x)dx∀T_{#}I₁=I₂. (15)
It is shown below that the optimal mapping T̅, among all constrained ray mappings, is the ray mapping of the optical problem. For this purpose, problem (Op) is related to problem (Mp) through several additional equivalent optimization problems. By introducing a new problem, denoted by (Wp), it can be proven that its solution is the pair (I,ψ) that solves (Op).
Theorem 1: Let σ=σ(x,z)≧0 and v=v(x,z)εR² be solutions of the following optimization problem:

$${inf}_{σ , v} W ( {I}_{1} , {I}_{2} ; P ) = {inf}_{σ , v} {\int }_{{Z}_{1}}^{{Z}_{2}} \int ( \frac{1}{2} σ {\vert v \vert}^{2} + P σ ) ⅆ x ⅆ z \qquad ( 16 )$$

subject to the constraints:

$$\begin{matrix}\frac{\partial σ}{\partial z} + ∇ \cdot ( σ v ) = 0 , {Z}_{1} \leq z \leq {Z}_{2} , σ ( x , {Z}_{i} ) = {I}_{i} ( x ) , i = 1 , 2. \\ Then , & ( 17 ) \\ σ = I , v = ∇ ψ , & ( 18 )\end{matrix}$$

where I and ψ solve (Op).

It can further be shown that the infimum of the functional W equals M defined in equation (13). Let (I,ψ) be the solution of problem (Wp). Use the phase ψ, i.e. the solution to the Hamilton-Jacobi equation (9), to define the following flow:

$$\frac{ⅆ \overline{x}}{ⅆ z} = ∇ ψ ( \overline{x} ( z ) , z ) , \overline{x} ( {Z}_{1} ) = x . \qquad ( 19 )$$

The flow (19) induces a mapping:
T_{Z}_{₁}^{z}(x):= x̅(z). (20)
Proposition 2: The mapping (20) transports I₁ to I(x,z).

The main result of this section can now be stated:

Theorem 3: The mapping T=T_{Z}_{₁}^{z=Z}^{₂}, where T_{Z}_{₁}^{z} is defined in (20), is the optimal mapping T̅, i.e.:
T̅=T_{Z}_{₁}^{Z}^{₂}. (21)
In addition,

$${inf}_{σ , v} W ( {I}_{1} , {I}_{2} ; P ) = \int Q ( x , \overline{T} ( x ) ) {I}_{1} ( x ) ⅆ x .$$

Theorem 1 states that the minimizing pair (I,ψ) for the functional W is a solution to the problem (Op). Theorem 3 states that the flow induced by ψ generates the optimal mapping T̅. Therefore, by solving the variational problem, one obtains complete information on the ray mapping and hence the phase ψ of problem (Op).

In the special case of the quadratic Monge problem, corresponding to the optical setup of a homogeneous medium, the action Q is minimized by the straight line (ray) connecting x and T(x). Therefore, the optimal map T̅ in this case is given explicitly by:
T_{Z}_{₁}^{Z}^{₂}(x)=x+∇ₓψ(x,Z₁)(Z₂−Z₁). (22)
Given two intensity distributions, and assuming that they are related by the paraxial Fresnel equations, the variational problem (Mp) provides one with a theoretical and practical tool to find a phase map that connects these intensities.

The mathematical analysis is valid for the optical problem (Op) regardless of its origin. The function P then has the interpretation of the potential of the physical system, and the z coordinate represents time. Therefore, the variational principle (Mp) means that if one is given the absolute value of the wave function everywhere in space at two different times Z₁ and Z₂, one can find the phase of the wave function at all times tε(Z₁, Z₂).

The Variational Problem II: General Waves

In the above Section, it was shown that the data embedded in the intensity distributions given on two planes suffices to find the phase of a wave in the paraxial regime. This finding naturally raises the question of whether the result can be extended to general waves. In this Section, a positive answer to this question is presented. The idea is to use the Fermat action itself (in a suitable form) as the action in the optimization problem and to phrase the intensity equation as an equation for the radiance.

Start by formulating the optical setup. Consider a solution to the Helmohltz equation:
Δu+k²n²(x,z)u=0 (23)
of the form u=A(x,z)e^{ikφ(x,z)}. Expanding as usual in large k, one obtains the eikonal equation

$${( \frac{\partial ϕ}{\partial z} )}^{2} + {\vert ∇ ϕ \vert}^{2} = {n}^{2} ,$$

for the phase φ, and the transport equation:

$${\partial }_{z} ( I \frac{\partial ϕ}{\partial z} ) + ∇ \cdot ( I ∇ ϕ ) = 0 , \qquad ( 24 )$$

for the intensity I=A². Here, as before, x denotes a point in the plane orthogonal to the z direction, and ∇ is the two dimensional gradient. Because one is not limited now to paraxial rays, there is some freedom in choosing the z axis. When considering general waves, it is more appropriate to introduce the radiance function. Therefore, define the radiance

$$ρ ( x , z ) = I \frac{\partial ϕ}{\partial z} = I \sqrt{{n}^{2} - {\vert ∇ ϕ \vert}^{2}} ,$$

and write the transport equation (24) with respect to it. Consider the case where the radiance is given on two parallel planes choose the z axis to be orthogonal to the planes.

To formulate the optical problem (O), find the phase function φ(x,z) and the radiance function ρ(x,z) such that ρ and φ satisfy:

$$\begin{matrix}\frac{\partial ρ}{\partial z} + ∇ \cdot ( ρ \frac{∇ ϕ}{\sqrt{{n}^{2} - {\vert ∇ ϕ \vert}^{2}}} ) = 0 {Z}_{1} < z < {Z}_{2} , \\ and & ( 25 ) \\ {( \frac{\partial ϕ}{\partial z} )}^{2} + {\vert ∇ ϕ \vert}^{2} = {n}^{2} , {Z}_{1} < z < {Z}_{2} , & ( 26 )\end{matrix}$$

subject to ρ(z=Z₁,x)=ρ₁(x), ρ(z=Z₂, x)=ρ₂(x), where ρ₁ and ρ₂ are two given radiance distributions. The question posed is whether problem (O) is solvable, and, in particular, whether it can be associated with an optimization (variational) principle.

The second variational problem, denoted by problem (M), is:

Find a map T̅ such that T̅_{#}ρ₁=ρ₂, and
∫Q(x, T̅(x))ρ₁(x)dx≦∫Q(x,T(x))ρ₁(x)dx∀T_{#}ρ₁=ρ₂, (27)

where the action Q is given by

$$Q ( x , y ) = min {\int }_{x}^{y} n ⅆ l = min {\int }_{{Z}_{1}}^{{Z}_{2}} n ( x , z ) \sqrt{1 + \frac{1}{2} {\vert \frac{ⅆ x}{ⅆ z} \vert}^{2}} ⅆ z , \qquad ( 28 )$$

and where the minimization is among all orbits x(z) such that x(Z₁)=x, x(Z₂)=y.

The optimal mapping T̅ is the ray mapping associated with (O). A key point in the analysis in the previous Section was the introduction of the corresponding Lagrangian equation (16). Thus, this analysis proceeds by defining an appropriate Lagrangian equation. The minimization of this Lagrangian equation is equivalent to the optical problem (O):
Theorem 5: Let ρ=ρ(x,z)≧0 and v=v(x,z)εR² be solutions of the following optimization problem:

$${inf}_{ρ , v} W ( {I}_{1} , {I}_{2} ; P ) := {inf}_{ρ , v} {\int }_{{Z}_{1}}^{{Z}_{2}} \int n ρ \sqrt{1 + {v}^{2}} ⅆ x ⅆ z , \qquad ( 29 )$$

subject to the constraints:

$$\begin{matrix}\frac{\partial ρ}{\partial z} + ∇ \cdot ( ρ v ) = 0 , {Z}_{1} \leq z \leq {Z}_{2} , ρ ( x , {Z}_{i} ) = {ρ}_{i} ( x ) , i = 1 , 2. \\ Then , & ( 30 ) \\ v = \frac{∇ ϕ}{\sqrt{{n}^{2} - {\vert ∇ ϕ \vert}^{2}}} , & ( 31 )\end{matrix}$$

where φ solves equation (26).

Similarly to Proposition 2, the flow T_{Z}_{₁}^{z}(x)= x̅(z), defined by:

$$\frac{ⅆ \overline{x}}{ⅆ z} = v = \frac{∇ ϕ}{\sqrt{{n}^{2} - {\vert ∇ ϕ \vert}^{2}}} , \overline{x} ( {Z}_{1} ) = x \qquad ( 32 )$$

transports ρ₁. Moreover, this flow induces the optimal mapping T̅.

The different optimization problems associated with the problem (O) are now summarized:

Theorem 6:

(i) The optimal mapping T̅ for problem (M) induces a ray mapping for the optical problem (O).

(ii)

$${inf}_{ρ , v} {\int }_{{Z}_{1}}^{{Z}_{2}} \int ρ n \sqrt{1 + {v}^{2}} ⅆ z ⅆ x = {inf}_{T} \int Q ( x , T ( x ) ) {ρ}_{1} ⅆ x = {sup}_{ϕ} \int {ϕρ}_{2} ⅆ x - \int {ϕρ}_{1} ⅆ x , \qquad ( 33 )$$

where the first integral is minimized under the constraint (30), the second integral is minimized among all maps T that transport ρ₁ to ρ₂, and the last integral is maximized among all functions φ that satisfy

$${( \frac{\partial ϕ}{\partial z} )}^{2} + {\vert ∇ ϕ \vert}^{2} \leq {n}^{2} .$$

The optical problem (O) was formulated in terms of the phase function ρ(x,z). If the expression for the radiance function in terms of the intensity function I is substituted into equation (25), then, upon making use of equation (26) it is found that the intensity I also solves equation (25). Therefore, the radiance function p can be replaced in the presentation above by the intensity function I. This implies that the phase can be determined by either intensity or by radiance measurements.

General Discussion

The analysis provided in the previous Sections provides one with a useful tool/method for determining the phase of a wave from intensity measurements. The optical problems (Op) or (O) are difficult to solve because one is given information on the intensity or radiance at two separate planes, constrained by certain differential equations connecting them. The variational problems (Mp) or (M), on the other hand, provide a direct optimization problem to find the solution.

One may interpret the result as a way to give a physical meaning to the notion of a ‘ray’. Rays are mathematical rather than physical entities. One cannot measure rays directly but the variational principle derived above provides a means for ‘measuring rays’. Actually, intensities are measured, and then, through the mathematical procedure of finding the optimal mapping, the individual rays are identified (i.e., the optically correct family of constrained ray mapping is constructed).

Implementation in Phase Sensors

The method described above for determining the phase of a wave can be utilized by a phase sensor to calculate the phase of a wave. Generally, phase sensors are devices that measure the phase of a wave, and are useful in a variety of applications in physics and technology. Phase sensors also form an important part of adaptive optics systems. Particular applications of phase sensors emerged in recent years in opthalmology. For example, as already discussed, an aberrometer is a device that utilizes a phase sensor to measure the shape of a wavefront generated by a light source on the retina, as the light wave exits from the eye. Most current aberrometers use a Hartmann-Shack phase sensor, whose shortcomings were discussed above. While other types of phase sensors (i.e. curvature sensors) calculate the phase of a wave based on intensity measurements, as explained above, these types of sensors that use the TIE equation have a number of shortcomings. For example, it is not clear how to obtain boundary conditions for the TIE equation (4). In addition, a practical serious shortcoming is that, in the TIE equation, one needs to differentiate the measured intensities. Because measurement errors are inevitable, and because it is well-known that noise in data is amplified by a differentiation step, a phase sensor that utilizes the TIE equation (4) may provide inaccurate results, even if one somehow overcomes the serious obstacle of obtaining boundary conditions.

The system and method of the present invention overcome all the shortcomings mentioned herein. The present invention provides the phase at high resolution, is not limited to paraxial waves, uses intensity detection screens that need not be placed very close to each other and the measured data is not differentiated.

It is now explained how to utilize the above-described equations in a system and method to determine the phase of a wave. The first step in determine the phase of the wave is to measure the intensity of the wave with at least two detection screens (i.e., a medium able to record and visually display information) of a measuring device, such as a phase sensor. Consider a wave propagating essentially along the z direction of a standard x, y, z axis. A measuring device detects the wave's intensity on a number of detection screens along its path. While at least two screens can be used, one can also use three or more screens to improve accuracy. Any type of phase detection screen can be used, including but not limited to, CCD screens, to provide the intensity at a high resolution.

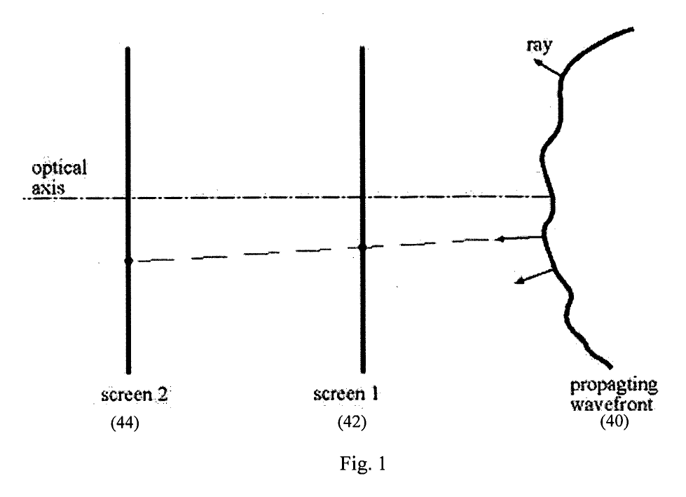

Referring now to FIG. 1, there is shown a schematic diagram of a wavefront 40 propagating toward the first and second detection screens 42 and 44 of one embodiment of the present invention. As shown, the wavefront 40 will meet the first screen 42 before reaching the second screen 44. As previously described, first screen 42 and second screen 44 do not need to be located in close proximity to each other, and can be arbitrarily located in space and in different planes. The only limitation on the location of first screen 42 and second screen 44 is that they must be positioned to measure a first intensity of the wave with first screen 42 and a second intensity of the wave with second screen 44. While not shown in FIG. 1, more than two screens can be used to measure the intensity of the wavefront and the additional screens will be placed apart from one and another and the other screens, just as the first screen 42 and second screen 44 are placed apart from one another in FIG. 1. Any additional screen will be positioned to measure an intensity that corresponds to the number of screens it represents in the measuring device (e.g. a third screen will be positioned to measure a third intensity, a fourth screen will be measured to measure a fourth intensity, etc.).

The second step of calculating the phase of the wave in this embodiment is to utilize a device, such as a computer, processor, microprocessor and/or a computer chip, to analyze the measured data and to determine the wave's phase. The computing element can use one of several algorithms that will be explained in some detail hereinafter. For simplicity, the algorithms presented are for the special (but very frequent) problem Mpq described above. To recall, problem Mpq (a.k.a. the quadratic Monge problem) consists of finding the optimal mapping T that solves the optimization problem (15). In general, the phase reconstruction performed by the computing element can be divided into two subparts. First, the optimal mapping T is constructed, and then the optimal mapping is used to construct the phase.

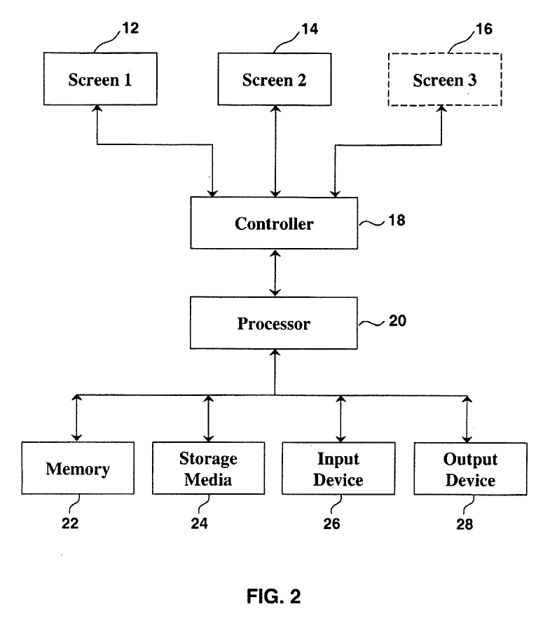

Referring now to FIG. 2, there is shown a block diagram of one embodiment of the system according to the present invention. In this embodiment, the system includes first screen 12, second screen 14, and, optionally, third screen 16. The system also includes controller 18, processor 20, memory 22, storage media 24, input device 26, and output device 28 all operatively connected to one another. As used herein, operatively connected includes any number of means of connecting electronics together known in the art including, but not limited to, a network, cables, wires, or wireless communication. In this embodiment, first, second and third screens 12, 14, and 16 comprise CCD screens operatively connected to and in bidirectional communication with controller 18 by means well known in the art. Controller 18 controls operations of first, second, and third screens 12, 14, and 16 (i.e., controls the provision of power to and instructs pictures to be taken on first, second, and third screens 16). Controller 18 also collects the data (image) collected on each of first, second, and third screens 12, 14, and 16. As already discussed, any number of screens can be used and connected to the controller 18, just as screens 12, 14, and 16 are connected to controller 18. Controller 18 can comprise a computer, processor, a microprocessor and/or other like device.

Processor 20 constructs the optimal mapping from the intensities measured on first, second, and third screens 12, 14, and 16. Processor 20 further computes the phase from the measured intensities. Processor 20 is operatively connected to memory 22 for execution of the program and non-permanent storage of data and calculations, to storage media 24 (i.e. a database) for storage of data (and/or results), to input device 26 (i.e., a keyboard) for operating processor 20, and output device 28 (i.e., a printer or computer screen) for output (such as printing or electronic communication) of results obtained from processor 20 by means well known in the art. Processor 20 can comprise a computer, processor, a microprocessor, and/or other like device.

It will be appreciated by those of skill in the art that controller 18 may be packaged with the screens, or separate controllers may be tightly coupled with each of the screens by means well known in the art (i.e., a network). Also, controller 18 and processor 20 may share a common processing unit, such as computer workstation. It will be further appreciated that processor 20, memory 22, storage media 24, input device 26, and output device 28 may comprise separate combinations or be included in a single unit, such as a computer workstation.

The following examples are included to demonstrate some of the possible embodiments of the invention. It should be appreciated by those of ordinary skill in the art that the techniques disclosed in the examples which follow represent techniques discovered by the inventors to function well in the practice of the invention, and thus, can be considered to constitute preferred modes for its practice. However, those of ordinary skill in the art should, in light of the present disclosure, appreciate that many changes can be made in the specific embodiments which are disclosed and still obtain a like or similar result without departing from the spirit and scope of the invention.

### Examples for Algorithms for Constructing the Optimal Mapping T̅

While the derivation in the Variational Problems I and II sections above were formulated for intensity functions defined over the entire plane, the theory is valid, of course, also for the special case where I₁ and I₂ are supported on finite domains, say D₁ and D₂, respectively. These domains can, for example, be associated with the system's aperture. It will be appreciated that there are many ways to estimate the domains D₁ and D₂. For example, since most apertures are circular, one can select the domain D₁ to be a disc. One option to selecting the domain D₂ is to seek a disc in the plane P₂ such that the integral of the intensity I₂ over the disc D₂ will be the same as the integral of the intensity I₁ over the disc D₁. Another way to select D₂ is to image on the screen P₂ a very fine ring placed on the plane P₁. Yet another way to determine the domain D₂ is to image on the plane P₂ a set of points that are located on the perimeter of the domain D₁ on the plane P₁.

In principle, the goal is to solve an optimization problem as explained in detail in the previous Sections. In light of the special nature of the optimization problem at hand, some specialized techniques found to be particularly useful are presented here.

I. Exemplary Method I: A Linear Programming Optimization Method

The quadratic Monge optimization problem (Mpq) can be converted into a linear programming problem that can then be solved by well-known techniques. This is done by associating problem (Mpq) with the Kantorovich minimization problem (K):

The idea is to consider the problem of minimizing the functional
K(m)=∫|x−y|²m(x,y)dxdy. (34)
The minimization is over all densities m such that their marginal density is given by I₁ and I₂, respectively, i.e.:
∫m(x,y)dx=I₂(y), ∫m(x,y)dy=I₁(x). (35)
Recall that both x and y denote points in the plane. The problem of minimizing K under (35) has a unique solution. Moreover, the minimizer m is supported exactly on the graph of the optimal mapping T̅ defined above, namely m̅(x,y)=δ(x− T̅(x)), where m̅ is the optimal Kantorovich density.

To implement the Kantorovich method, the densities I₁, I₂ need to be discretized. That is, the intensities I₁,I₂ are approximated with discrete distributions. For this purpose, select points {xᵢ}, {yᵢ} according to empirical distributions, namely:

$${I}_{1} \approx \frac{1}{N} {\sum }_{i}^{N} {δ}_{{x}_{i}} , {I}_{2} \approx \frac{1}{N} {\sum }_{i}^{N} {δ}_{{y}_{i}} . \qquad ( 36 )$$

where {δₓ_{ᵢ}δ_{y}_{ⱼ}} are unit point masses, and Σmᵢ⁽¹⁾=Σmᵢ⁽²⁾=1. The corresponding Kantorovich problem (34) takes the form

$${min}_{M} {\sum }_{i = 1}^{N} {\sum }_{j = 1}^{N} {M}_{i , j} {\vert {x}_{i} - {y}_{j} \vert}^{2} , \qquad ( 37 )$$

where the minimum is taken on all non-negative, N×N matrices M which satisfy ΣᵢM_{i,j}=ΣⱼM_{j,i}=1/N.

This formulation has a unique minimizer which is a permutation matrix M_{i,j}=(1/N)δ_{i,j(i)}. The permutation defines a discrete mapping:
Å:{1, . . . N}→{1, . . . N},
   which is the solution of the discrete optimal mapping via:
   T(xᵢ)=y_{Å(i)}.

The algorithm requires a selection of points in accordance with empirical distributions (36) that carry identical mass with respect to the intensities I₁ and I₂. This can be done in a variety of ways. For instance, a simple suitable sampling method for the case where D₁ and D₂ are rectangles is proposed in the “Minimizing Flows for the Monge-Kantorovich” article by S. Angenent, S. Haker and A. Tannenbaum that appears in the 2003 SIAM Journal of Mathematics Annals No. 35, pages 61-97 (the “Angenent Article”), which is incorporated herein by reference. It is clear to one of ordinary skill in the art how to construct a similar sampling for discs and other domains.

The optimization problem (Mpq) (and therefore also the problem of phase determination from intensity measurements) was thus converted into a linear programming problems that is simple to implement on processor 20. The main drawback of the linear programming problems is that it requires work with functions of four variables, which implies a need for a system with a large computer memory.

II. Exemplary Method II: A Steepest Descent Flow Method

Gradient methods, such as the steepest descent flow method, are common in optimization. The idea is to define a flow that proceeds along the gradient of the Monge functional, while always preserving the constraint that the mapping transports I₁ into I₂. A steepest descent flow for the problem (Mpq) was computed in the Angenent Article. To emphasize that this flow of transformations is not directly related to the optical flow, but rather, is a mathematical way for finding the optimal transporting map T̅, introduce the flow as:
U=U(x,t):R²×[0,∞)→R²
and the parameter t to denote ‘time’ for the flow. The flow starts with an initial mapping U₀(x)=U(x,0) that transports I₁ to I₂. For example, the sampling (36) with trivial permutation can be used to generate an initial mapping.

In the algorithm of the Angenent Article one decomposes U at each time t into the orthogonal sum of a gradient and a divergence-free vector field:
U(x,t)=∇p(x,t)+v(x,t), ∇·v=0. (38)
When dealing with bounded domains, the requirement that v is divergence-free must be supplemented with the boundary behavior of v. The natural boundary condition is that the vector field v has no normal component at the boundary. Together, the requirements on v imply that p must solve the following Poisson-Neumann problem:

$$Δ p = ∇ \cdot U x ∈ {D}_{1} , \frac{\partial p}{\partial v} = U \cdot v x ∈ \partial {D}_{1} , \qquad ( 39 )$$

where v is the outward normal to D₁. Equivalently, the potential p can be characterized as the function that minimizes the functional:
F(p)=∫|U−∇p|²dx. (40)
The evolution of U is driven by:

$$\frac{\partial U}{\partial t} + \frac{1}{{I}_{1}} v \cdot ∇ U = 0. \qquad ( 41 )$$

The evolution problem (38), (39), (41) is referred to herein as the AHT flow.

An alternative steepest descent flow can be formulated by decomposing U differently. For example, one can replace the projection (38) by the orthogonal projection:
U(x,t)=∇q(x,t)+w(x,t), ∇·(I₁w)=0. (42)
The gradient flow (41) is replaced by the flow:

$$\frac{\partial U}{\partial t} + w \cdot ∇ U = 0. \qquad ( 43 )$$

The implementation and use of the steepest descent flow on the processor 20 is now described. For example, a discretized algorithm for the AHT flow is presented. The data is naturally provided in a discrete form. The first step is to construct a discrete grid on which U(x,t) will be evaluated. There are many ways for grid generation, and any such grid can be used. Typically, the domain will be a disc, and it is well-known how to construct good grids in discs. The grid on the disc provides the space discretization. In solving the evolution equation (41), the t variable must be discretized. Again, such discretization techniques are well-known, in particular in the context of fluid mechanics and conservation laws.

Denote the discrete time levels by {tᵢ}. The initial sampling is used to construct U at time t₀=0 at the space grid points. For each discrete time step, the vector field v that appears in (41) is found. Once v is known at time step tᵢ, the value of U at time t_{i+1,}is updated using v, the known U at tᵢ and equation (41). One way to find v at time step tᵢ is to solve equation (39) using the known U at time tᵢ, and to use equation (38) to form v. Because the constraint ∇·v=0 appearing in (38) is very important to satisfy, an alternative method can be used that is based on the stream function notion, such as is very common in fluid mechanics. For this purpose, a stream function Ψ(x,t), such that ∇̅Ψ=v, where the symbol ∇̅ denotes the operator conjugate to the gradient operator, is introduced. This means that the components v₁,v₂ of v are given by:

$${v}_{1} = - \frac{\partial Ψ}{\partial y} , {v}_{2} = \frac{\partial Ψ}{\partial x} .$$

The advantage of working with Ψ is that v is automatically divergence-free as required. Operating on (38) with Δx, and using the fact that no flow exits D₁, Ψ satisfies the Poisson problem:
ΔΨ=∇×UxεD₁, Ψ(x)=0, xε∂D₁. (44)
At each time step tᵢ the Poisson equation (44) is solved to obtain Ψ at tᵢ. From Ψ, v is obtained and then (41) is propagated to obtain U at time step tᵢ₊₁. Equation (44) can be easily solved, for example, by the well-known finite elements method. One proceeds to update U for times tᵢ until one observes convergence to a minimizer U̅. There are several ways to detect convergence. For example, one can check that the updated U for some tⱼ is almost the same as U at time tⱼ₋₁. Another criterion for convergence is to check whether that v becomes smaller than some predetermined threshold.

### Constructing the Phase from the Optimal Mapping T̅

After the optimal mapping T̅ is computed utilizing one of the above-listed algorithms or one substantially similar to it, the phase of the wave can be determined. The optimal mapping T̅ that was computed in the previous examples provide an association between points on two screens. This association is in fact induced by light rays connecting each pair of associated points. Therefore, knowing T̅ means that the rays are known. Given a system of rays associated with a propagating wavefront, it is a simple matter to integrate the phase itself, and there are several well-known algorithms for this purpose.

The method presented hereinabove is based on measuring the intensity on two screens. It is also possible to execute the invention by using three or even more screens. For example, if three screens are used, say screens 1, 2, and 3, then one can first find the ray mapping from screen 1 to screen 2 and from screen 2 to screen 3, as explained hereinabove. Each such ray mapping provides the rays through screen 2. It might be that the rays obtained for the association of points between screens 1 and 2 will not be exactly the same as the rays obtained between screens 2 and 3. Such difference may be, for example, caused by measurement inaccuracies. One can then average the two values obtained for each ray, and thus reduce the effect of such differences.

The present invention as discussed hereinabove is formulated for monochromatic waves. In practice, the light may be polychromatic. It will be appreciated that the optimization problem ((15), for example) does not depend on the wavelength. Therefore, it can be solved regardless of the wavelength. When determining an actual phase, one must specify a wavenumber k. There are several ways of selecting an effective wavenumber k. For example, in the case where the system is illuminated by a known light source, one can choose as an effective wavenumber k the average wavenumber, weighted with respect to the spectral output of the light source.

While the present invention has been described in detail with reference to certain exemplary embodiments thereof, such are offered by way of non-limiting example of the invention, as other versions are possible. For example, as will be appreciated by one skilled in the art, additional steps might need to be taken for determining the phase of the wave from the intensities. Such additional steps could include, but are not limited to, filtering the intensity measurement to remove noise. It is anticipated that a variety of other modifications and changes will be apparent to those having ordinary skill in the art and that such modifications and changes are intended to be encompassed within the spirit and scope of the invention as defined by the following claims.

We claim:

1. A device for determining a phase of a wave, the device comprising:
(a) a first screen for measuring a first intensity of the wave;
(b) a second screen for measuring a second intensity of the wave; and
(c) a processor operatively connected to the first and second screens in order to collect the measured first and second intensities, the processor capable of constructing optimal mapping from the first measured intensity and from the second measured intensity, and capable of calculating the phase from the constructed optimal mapping.

2. The device of claim 1 further comprising a third screen for measuring a third intensity of the wave.

3. The device of claim 2 wherein the processor is operatively connected to the first, second and third screens, the processor capable of constructing optimal mapping from the first measured intensity, the second measured intensity, and the third measured intensity, and capable of calculating the phase from the constructed optimal mapping.

4. The device of claims 1 wherein the processor utilizes a linear programming optimization to construct the optimal mapping.

5. The device of claim 1 wherein the processor utilizes a steepest descent flow to construct the optimal mapping.

6. The device of claim 1 wherein the second screen is located in a different plane than the first screen.

7. The device of claim 1 wherein the wave comprises a nonsymmetric wave.

8. The device of claim 1 wherein the wave comprises a paraxial wave.

9. The device of claim 1 wherein the wave comprises a nonparaxial wave.

10. The device of claim 1 wherein the processor comprises a computer.

11. A method for determining a phase of a wave, the method comprising the steps of:
(a) providing a first screen for measuring a first intensity of the wave, a second screen for measuring a second intensity of the wave, and a processor operatively connected to the first and second screens;
(b) measuring the first intensity of the wave with the first screen;
(c) measuring the second intensity of the wave with the second screen;
(d) collecting the measured first and second intensities and constructing optimal mapping with the processor from the first intensity and the second intensity; and
(e) calculating the phase of the wave from the constructed optimal mapping with the processor.

12. The method of claim 11 wherein the providing step further provides a third screen for measuring a third intensity of the wave.

13. The method of claim 12 further comprising the step of measuring the third intensity of the wave with the third screen.

14. The method of claim 13 wherein the constructing optimal mapping step constructs the optimal map with the processor from the first, second and third intensities.

15. The method of claim 11 wherein the constructing optimal mapping step comprises the step of utilizing a linear programming optimization in the processor based on the first intensity and the second intensity to calculate the optimal mapping.

16. The method of claim 11 wherein the constructing optimal mapping step comprises the step of utilizing a steepest descent flow in the processor based on the first intensity and the second intensity to calculate the optimal mapping.

17. The method of claim 11 wherein the method determines the phase of a nonsymmetric wave.

18. The method of claim 11 wherein the method determines the phase of a paraxial wave.

19. The method of claim 11 wherein the method determines the phase of a nonparaxial wave.

20. The method of claim 11 where said step of constructing optimal mapping includes the steps of:
(a) using the measured first and second intensities to construct a family of constrained ray mappings and to define a weighted least action functional; and
(b) optimizing said weighted least action functional among all mappings in said family of constrained ray mappings.

21. A device for determining a phase of a wave, the device comprising:
(a) at least two detection screens for measuring at least a first intensity and a second intensity at different locations; and
(b) a processor operatively connected to the at least two screens in order to collect the measured first and second intensities, the processor capable of constructing optimal mapping from the first measured intensity and from the second measured intensity, and capable of calculating the phase from the constructed optimal mapping.

22. The device of claim 21 wherein the at least two detection screens are located in different planes.

23. The device of claim 21 wherein the wave comprises a nonsymmetric wave.

24. The device of claim 21 wherein the wave comprises a paraxial wave.

25. The device of claim 22 wherein the wave comprises a nonparaxial wave.

26. The device of claim 22 wherein the processor comprises a computer.
